(19) United States
(12) Patent Application Publication
(10) Pub. No.: US 2015/0269856 A1
(43) Pub. Date: Sep. 24, 2015

(54) VIRTUAL CLASSROOM MANAGEMENT SYSTEM AND INTERFACE

(71) Applicant: GURU LABS, L.C., CENTERVILLE, UT (US)

(72) Inventor: Dax James de Carvalho Kelson, Eden, UT (US)

(73) Assignee: GURU LABS, L.C., CENTERVILLE, UT (US)

(21) Appl. No.: 14/223,970

(22) Filed: Mar. 24, 2014

(51) Int. Cl. G09B 5/12

(52) U.S. Cl. CPC G09B 5/12

(57) ABSTRACT

A method for displaying information to an instructor relating to the activities of one or more students within a virtual classroom may include remotely accessing a plurality of computer systems. The computer systems may include student computer interfaces configured to provide students with one or more necessary components for a virtual class. Additionally, the method can include displaying, within a first instructor interface, visual representations of a plurality of the student computer interfaces. The visual representations can depict views of the plurality of the student computer interfaces as seen by the students within the students' respective student computer interfaces. The method can also include updating at least a portion of the visual representations to include a visual depiction of student-driven manipulations applied to the respective student computer interfaces.

### BACKGROUND OF THE INVENTION

1. Technical Field

Embodiments of the present invention relate to virtual classroom environments.

2. Background and Relevant Art

Many individuals are now pursuing education and training through Internet based virtual classrooms. Virtual classrooms have a strong presence, in particular, within computer based technology classes. For example, virtual classes are available to students who wish to learn about computer programming, information technology, information systems, and other related fields.

In many cases, students can access virtual classes from any computer that meets the requirements that relate to a particular virtual class. For example, some virtual classes may require that a computer have Internet access and the appropriate proprietary and/or third part software installed. In some implementations, a student may also be further required to configure his or her network connection, including firewall settings, to insure that a network connection can be made between the student's computer and the appropriate virtual classroom server. In the case that the student is using a public network to connect to the virtual classroom, the student may not have sufficient rights to properly configure the network.

Similar to students, virtual classroom instructors may also struggle with some of the same limitations of the prior art. For example, the instructors may have to install various software components and configured his or her network connection in order to connect to the required servers and execute the required applications. Instructors would also likely have the same difficulties relying upon public networks that students would experience.

Additionally, from an instructor perspective, it may be difficult to monitor and assist the various students within a virtual classroom. For example, an instructor may not be able to readily identify students that require assistance with an assignment, are distracted, are experiencing computer problems, or otherwise need attention. In particular, instructors in virtual classrooms can be disadvantaged by the lack of real-time information relating to the progress of an entire virtual classroom.

### BRIEF SUMMARY OF THE INVENTION

Implementations of the present invention relate to systems, methods, and apparatus configured to manage virtual classrooms in a way that provides an instructor with individualized oversight of an entire virtual classroom. In particular, embodiments of virtual classroom management systems allow students and instructors to access a virtual classroom from any computer, without the use of third-party APIs. Additionally, implementations of virtual classroom management systems provide a virtual classroom instructor with live or automatically updating depictions of the activities of each of the various students within the virtual classroom.

For example, a method in accordance with at least one implementation for displaying information to an instructor relating to the activities of one or more students within a virtual classroom may include remotely accessing a plurality of computer systems. The computer systems may include student computer interfaces configured to provide students with one or more necessary components for a particular virtual class. Additionally, the method can include displaying, within a first instructor interface, visual representations of a plurality of the student computer interfaces. The visual representations can depict views of the plurality of the student computer interfaces as seen by the students within the students' respective student computer interfaces. The method can also include updating at least a portion of the visual representations to include a visual depiction of student-driven manipulations applied to the respective student computer interfaces.

In an additional or alternative embodiment, a system configured to display information to an instructor regarding the activities of one or more students within a virtual classroom can include a virtual classroom module executed on an instructor computer system. The virtual classroom module can receive from the instructor a request to enter a particular virtual classroom. The virtual classroom module can then display, within an instructor interface, the particular virtual classroom. The particular virtual classroom may include visual representations depicting views of a plurality of student computer interfaces as seen by students within the students' respective student computer interfaces. Additionally, the virtual classroom module can update at least a portion of the visual representations to include a visual depiction of student-driven manipulations applied to the respective student computer interfaces.

Additional features and advantages of exemplary implementations of virtual classroom management systems will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic illustration of an embodiment of a system for managing a virtual classroom;

FIG. 2 illustrates an embodiment of a user interface for an instructor of a virtual classroom;

FIG. 3 illustrates another embodiment of a user interface for an instructor of a virtual classroom;

FIG. 4 illustrates an embodiment of a virtual classroom selection interface;

FIG. 5 illustrates an example of a flowchart of a series of acts in a method for displaying information to an instructor relating to the activities of one or more students within a virtual classroom; and

FIG. 6 illustrates a flowchart of a series of acts performed by a system for displaying information to an instructor regarding the activities of one or more students within a virtual classroom.

### DETAILED DESCRIPTION OF THE PREFERRED EMBODIMENTS

An illustrative embodiment extends to systems, methods, and apparatus configured to manage virtual classrooms in a way that provides an instructor with individualized oversight of an entire virtual classroom. In particular, embodiments of virtual classroom management systems allow students and instructors to access a virtual classroom from any computer, without the use of third-party APIs. Additionally, implementations of virtual classroom management systems provide a virtual classroom instructor with live or automatically updating depictions of the activities of each of the various students within the virtual classroom.

Accordingly, one or more embodiments of a system for managing and displaying a virtual classroom allow a user to access the virtual classroom through a web browser. In particular, in at least one embodiment the virtual classroom is executable within a web browser using only native APIs, such that no additional 3^{rd} party plug-ins or applications are required for users to access the virtual classroom. Executing the virtual classroom within a web browser using standard Internet ports and APIs may allow virtual classroom to pass through various firewalls and network settings with minimal effort because the virtual classroom connection is viewed as a standard, firewall friendly web connection.

Additionally, one or more embodiments of an instructor interface for a virtual classroom provide real-time or near-real time views of the student computer interfaces for each student within a particular virtual classroom. Specifically, an instructor may be able to view the actions that each student is taking within the individual computer interfaces. In this way, embodiments of the instructor interface create a virtual classroom that allows an instructor to oversee an entire classroom and to easily identify potential student difficulties. In a real world classroom, an instructor is able to wander around the classroom and visually see the progress of each student. Similarly, in embodiments of the instructor interface, an instructor is able to visually inspect the actions of each student, as the student is taking the action.

Further, in at least one implementation of a virtual classroom management system. The rate at which the instructor's view of the student's computer interfaces is updated can be adjusted. In particular, if bandwidth constraints are a problem, either a student or an instructor can adjust the refresh rate to only update the instructors view at a particular interval (e.g., once every second, once every 5 seconds, etc.). Similarly, in at least one embodiment, the virtual classroom management system can automatically adjust the refresh rate if poor performance is detected.

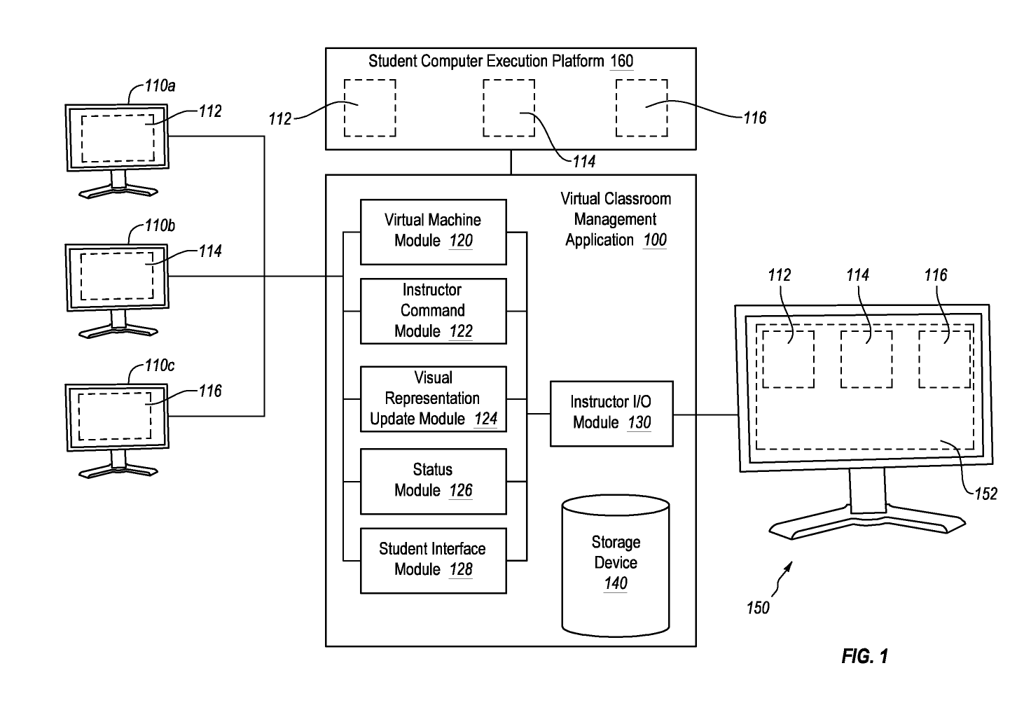

Turning now to the figures, FIG. 1 depicts a system for managing and virtual classroom. In particular, FIG. 1 depicts a virtual classroom management application 100. In various embodiments, the virtual classroom management application 100 can be stored and executed from a variety of different sources. For example, the virtual classroom management application 100 can be executed by a remote server, by an instructor's computer system, distributed over a network between the instructor and the students, or from any other source.

In the depicted embodiment, the virtual classroom management application 100 includes a virtual machine module 120, an instructor command module 122, a visual representation update module 124, a status module 126, a student interface module 128, an instructor I/O module 130, and a storage device 140. One will understand, however, that separating modules into discrete units is at least somewhat arbitrary and that modules can be combined, associated, or separated in ways other than shown in FIG. 1 and still accomplish the purposes of embodiments of this invention. Accordingly, the particular modules 120, 122, 124, 126, 128, 130, 140 of FIG. 1 are only shown for illustrative and exemplary purposes of at least one implementation.

The virtual classroom management application 100 is depicted as being in contact with a plurality of student computer systems 110(a-c). The student computers may include a variety of different forms including, but not limited to, desktop computers, laptop computers, tablets, mobile phones, or any other similar computing device. Through the student computer systems 110(a-c), one or more students can access a virtual classroom, as prepared by the virtual classroom management application 100.

In addition to being in communication with a plurality of student computer systems 110(a-c), the virtual classroom management application 100 can also be in communication with an instructor computer system 150. The instructor computer system 150 can be of any of the forms listed above for the student computer systems 110(a-c). Additionally, in at least one implementation, the virtual classroom management application 100 can primarily reside within and be executed from instructor computer system 150.

Further, in at least one embodiment, the virtual classroom management application 100 is also in communication with a Computer Interface Execution Platform 160. The Computer Interface Execution Platform 160 can be a component of the same system that is executing the virtual classroom management application 100, or can be executed on a separate system. In at least one implementation, the Computer Interface Execution Platform 160 provides a platform to execute the student computer interfaces 112, 114, 116 that will be viewable by the respective students and instructor. The student computer interfaces 112, 114, 116, as executed by the Computer Interface Execution Platform 160, can comprise virtual machines associated with the virtual machine module 120 or computer executable running natively on physical hardware provided by the Computer Interface Execution Platform 160.

Returning now to the modules 120, 122, 124, 126, 128, 130, 140 within the virtual classroom management application 100. In at least one implementation, the virtual machine module 120 can provide one or more virtual machines to the student computer systems 110(a-c) and/or to the instructor. In particular, the virtual machines can be preconfigured to have the necessary tools and components for a particular lesson and class. The virtual machines can further relate to a variety of different computer operating systems, embedded systems, virtual device interfaces, and other similar systems.

In at least one implementation, the virtual machine module 120 can communicate with the various computer systems through the student interface module 128 or the instructor I/O module 130. The virtual machine module 120 can be executed on the Computer Interface Execution Platform 160, such that the plurality of student computer systems 110(a-c) and/or instructor computer system 150 do not actually execute the virtual machine, but instead only interact with an interface of the virtual machine. In contrast, the virtual machine module 120 can be configured to provide each of the plurality of student computer systems 110(a-c) and/or instructor computer system 150 with a virtual machine image file that can be executed locally. In some embodiments, though, the instructor computer system 150 may only need to communicate with the server in order to receive the necessary updates and information regarding the students.

In various embodiments, the student interface module 128 and the instructor I/O module 130 can communicate to the various computer systems 110(a-c), 150 through a dedicated application installed on each respective computer system or through a general purpose web browser. For example, a student may be able to access a virtual classroom, including a virtual machine, through a general-purpose web browser. In this case, a completely functioning virtual machine operating system may be available within the web browser window for the student to interact with.

If communicating through a general-purpose web browser, in at least one implementation, the virtual classroom management application 100 can utilize native browser application program interfaces, such that plugins and/or third party executables are not required for a user to access a virtual classroom. In particular, in at least one implementation the virtual classroom management application 100 can communicate to a web browser through HTML and Application Programming Interfaces that are native to the web browser. As such, a student and/or instructor can be presented with a virtual classroom experience, possibly including a virtual machine, within a general-purpose web browser.

In addition to providing student computer systems 110(a-c) and instructor computer systems 150 with graphical user interfaces, in at least one implementation, the visual representation update module 124 can provide to the instructor I/O module 130 visual representation of the student computer interfaces 112, 114, 116 of each student computer system 110(a-c). The instructor I/O module 130 can then display to within an instructor interface 152 a live or automatically updating thumbnail visual representation of each student computer interface 112, 114, 116.

Additionally, in at least one embodiment, the visual representation update module 124 can continually update the multiple computer interfaces 112, 114, 116 such that an instructor can see visual depictions of student-driven manipulations being applied to the respective student computer interfaces 112, 114, 116. The ability to view the students' interfaces as they work through a lesson and/or lab can provide an instructor and the students with valuable accountability and feedback. For example, an instructor can identify students that are falling behind, stuck, or doing something incorrectly. Accordingly, one or more embodiments of a virtual classroom management application 100 provide an instructor with a virtual classroom that is similar to a real-world classroom in that the instructor can see the ongoing activities of each student.

The visual representation update module 124 can be configured to update that multiple computer interfaces 112, 114, 116 such that the instructor is able to view the student-driven manipulations in real-time, or near real-time. In at least one embodiment, real-time, or near real-time for the purposes of visual display includes any frame rate greater than 10 fps, or more preferably greater than 20 fps. Further in at least one embodiment, real-time or near real-time relates to an update frequency that occurs with significant enough frequency to capture within the multiple computer interfaces 112, 114, 116 each of the student-driven manipulations as they appear on the computer interfaces as seen by the students within the students' respective student computer interfaces.

In some situations, however, one or more of the student computer systems 110(a-c) and/or the instructor computer system 150 may not be able to support real-time or near real-time updating of the multiple computer interfaces 112, 114, 116 due to connectivity issues, computer processing power, or some other impediment. As such, in at least one embodiment, the visual representation update module 124 can adjust the update frequency of one or more of the multiple computer interfaces 112, 114, 116. For example, a particular student may determine that his or her network connection does not support sufficient bandwidth for real-time or near real-time updating. Accordingly, the particular student can submit a requested update frequency to the visual representation update module 124. The visual representation update module 124 can then adjust the update frequency in accordance with the request.

In addition to receiving a requested update frequency from a student, the visual representation update module 124 can also receive a requested update frequency from an instructor. For example, the instructor can request a specific update frequency for an individual computer interfaces (e.g., 112) or a specific update frequency to be applied to all of the multiple computer interfaces 112, 114, 116.

In contrast to receiving a requested update frequency from an instructor or a student, in at least one embodiment, the visual representation update module 124 can automatically adjust the update frequency in response to detected performance issues. For instance, if the visual representation update module 124 detects a performance problems with a particular student computer system (e.g., 110b), the visual representation update module 124 can automatically lower the update frequency to a rate that allows for acceptable performance of the student computer system 110b. Similarly, if the visual representation update module 124 identifies a performance problem with an instructor computer system 150, the visual representation update module 124 can automatically lower the update frequency rate of one or more of the student computer systems 110(a-c) to a rate that allows for acceptable performance of the instructor computer system 150.

Once an instructor has been provided with multiple computer interfaces 112, 114, 116 of student computer interfaces, the instructor command module 122 can allow an instructor to issue commands to and work within a particular student computer interface 112, 114, 116. Additionally, the status module 126 can receive status updates from students and can automatically identify status information. The status module 126 can provide this information to the Instructor I/O module 130, which can display the information within an instructor interface.

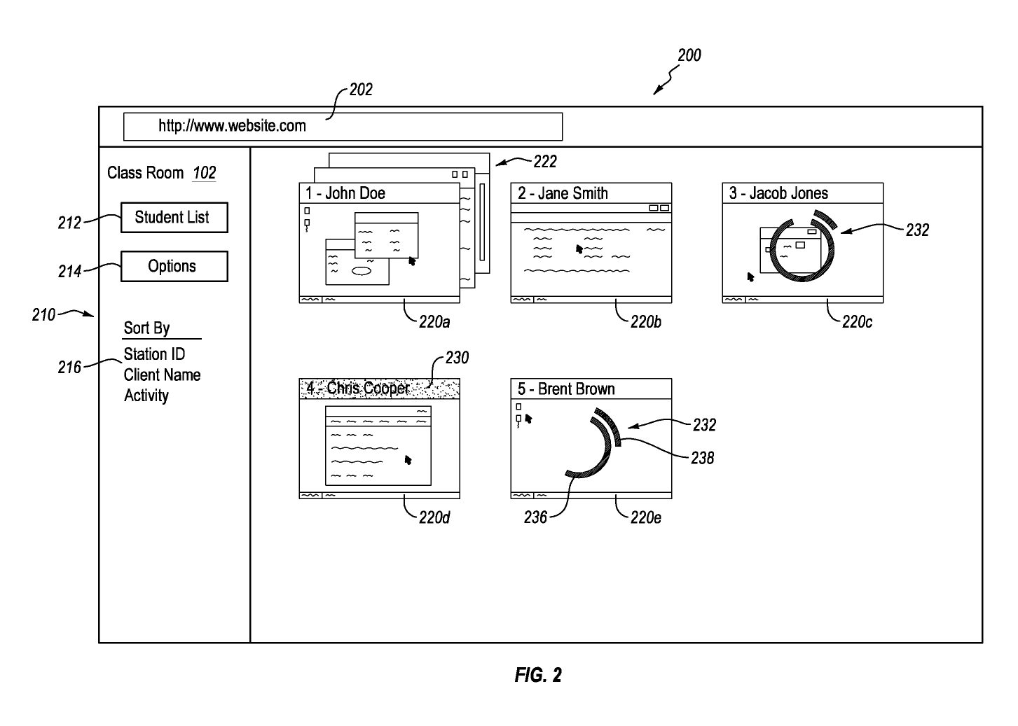

For example, FIG. 2 illustrates an instructor interface 200 for a virtual classroom. The depicted instructor interface 200 is contained within a web browser 202 and includes several visual representations 220(a-e) of various student interfaces. Each of the various student interfaces may be associated with a student that is a member of a specific virtual class. In at least one implementation, multiple computer interfaces 222 can be associated with a single student. For example, a particular virtual class may require each student be assigned multiple lab systems in order to create a multi-node cluster. Accordingly, the student may see visual representations of a plurality of systems assigned to him or herself akin to the instructor interface.

In the embodiment depicted by FIG. 2, the instructor interface provides a single viewable window that relates to at least one visual representation 220(a-e) associated with every student in the class. As such, an instructor is provided with an interface that allows the instructor to view the activity of every student within the virtual classroom simultaneously. In at least one embodiment, when a particular student is associated with multiple computer interfaces 222, the visual representation that is currently being manipulated by the student is automatically moved to the top, or otherwise made visible or the multiple computer interfaces 222 assigned to that student are displayed with a node number in the title (e.g., Node1).

In an alternative embodiment, when multiple computer interfaces 222 are associated with a specific student, the multiple computer interfaces 222 are not stacked, but are instead presented in a flat format (e.g, a row or column). Each of the multiple computer interfaces 222 can comprise a unique identifier. For example, the multiple computer interfaces 22 can be identified as “John Doe—Node 1,” “John Doe—Node 2,” “John Doe—Node 3,” etc. As such, an instructor is able to simultaneously view the content of each of the multiple computer interfaces 222. Additionally, in this embodiment, the computer interface that the student is currently interacting with may indicate a specific color or graphical element that communicates to the instructor the active computer interface.

When using multiple computer interfaces 222, in at least one implementation, the student can view an interface similar to the instructor's interface 200, in that the student can view multiple interfaces 222 within a single window or page. In contrast to the instructor interface 200, however, the student may only have access to the multiple computer interfaces 222 that are associated with the student.

In addition to displaying visual representations 220(a-e) of one or more student interfaces, in at least one embodiment, the status module 126 can provide the instructor interface with visual indicators 230, 232, 236, 238 that provide at a glance information regarding the various visual representations 220(a-e). Specifically, the visual indicators may include a pre-defined grouping of symbols, colors, visual effects, accompanying sounds, and similar notifications that are each individually associated with a particular event. As such, an instructor can easily and quickly identify the states of various visual representations by merely identifying the presence of a visual indicator. For example, student interface 220d includes a colored bar 230 at the top of the visual representation 220d. The colored bar can indicated a student interface that is inactive, a student interface that is active, a student request for help, or some other similar indication.

Additionally, student interfaces 220c and 220e include idle timers 232 that indicate that the particular student interfaces 220c, 220e have been idle. The idle timers 232 can be configured such that an inner circle 236 performs as a timer that at a constant speed continuously rotates in a circle. The idle timer 232 can also include an outer circle 238 that spins at a slower speed than the inner circle 236. For example, the outer circle 238 may only increment each time the inner circle 236 completes a revolution. Additionally, the inner circle 236 can be periodic to a specific time interval, for example, one minute. The outer circle 238 can also be periodic to a greater time interval, for example, fifteen minutes. The idle timer can alternately be a textual representation (eg., ‘3 min 20 seconds”) instead of the graphical representation if the instructor prefers.

In addition to the status module 126 automatically generating various status indicators, in at least one embodiment, a student can generate a status indicator. For example, a particular student may be struggling with a portion of an assignment. The student may be able to engage a help status indicator. In response to the help status indicator, the visual representation that is associated with the student can blink, gain a colored bar, or otherwise issue a visual indicator. In addition to visual indicators, the instructor interface 200 can also issue an audio alarm.

In at least one implementation, a variety of different colors, symbols, and/or sounds can be used to indicate variety of different information regarding the individual student interfaces. Accordingly, embodiments of the instructor interface 200 provide virtual notification that are akin to notification a instructor would receive in a real-world classroom if a student needed help.

The instructor interface also includes information and options directed towards managing a virtual classroom. For example, an instructor may be provided with a “student list” option 212. In at least one embodiment, the student list options 212 provides an instructor with a listing of students currently enrolled within a particular virtual class, in addition to personal information about each student. For instance, the student list option 212 may provide an instructor with personal contact information for the various students within the class.

Additionally, an instructor is also provided with a “sort by” option 210 that allows the visual representations to be sorted according to a variety of different orders 216. For example, an instructor can sort the visual representations based upon the station ID, the client name, and/or the activity of the particular visual representation. Sorting by activity level, for example, may provide an instructor with a quick method to identify the students that are actively working on a project versus the students that are not working on the project.

The instructor interface 200 may also provide an options button 214 to an instructor. The options button 214 may allow an instructor to adjust various user preferences relating to the virtual classroom, such as visual representation update frequency. Additionally, the options button 214 may allow an instructor to manipulate the various student interfaces 220(a-e). For example, an instructor may be able to issue various standard commands such as restart, log-off, or shutdown commands to one or more of the student interfaces 220(a-e). Specifically, the instructor command module 122 can receives the selected option from the Instructor I/O module. The instructor command module 122 can then issue the option to the one or more student interfaces.

In addition to issuing standard commands, in at least one embodiment, the instructor can also restore, or rollback, one or more student interfaces to a previous time. For example, if a particular student interface is experiencing technical problems, an instructor can issue a command to restore the particular student interface to a previous time when the student interface was known to be stable. In at least one implementation, a restore command can access the storage devices 140 that is associated with the virtual classroom management application 100. The storage device 140 may include a repository of various states of each student interface. For example, in at least one implementation, the storage device 140 only contains a single clean install image of each student interface. In contrast, in at least one implementation, the storage device 140 contains a plurality of different version of each student interface, where each version is associated with a particular point in time. Once a particular restore point is identified, the virtual classroom management application 100 can revert the student interface to the particular restore point.

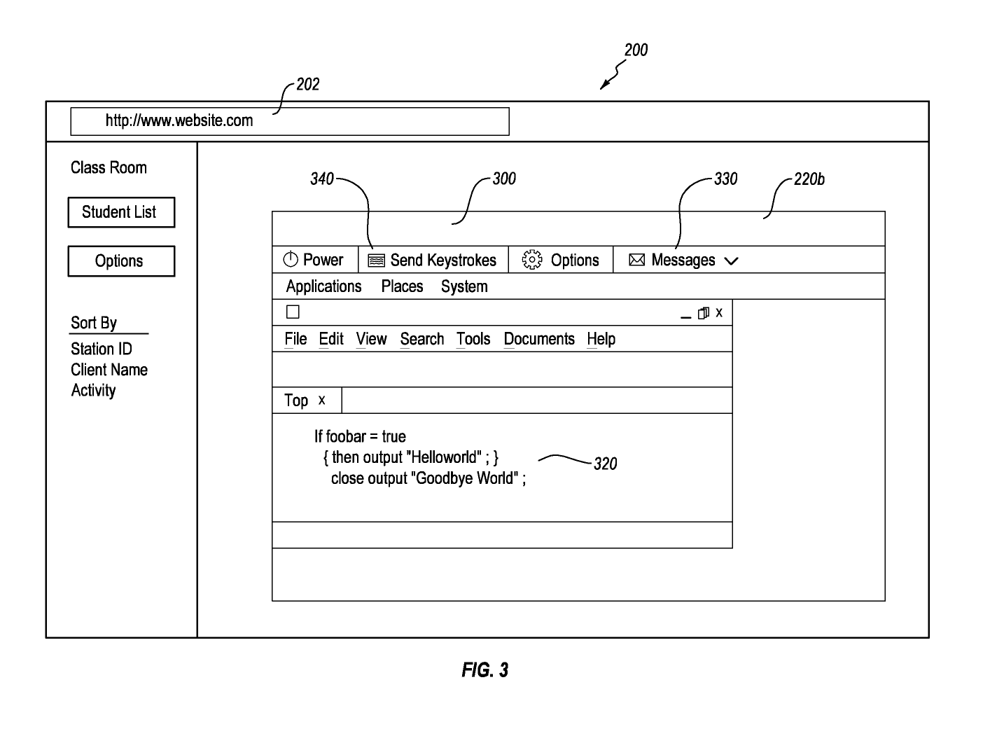

Turning now to FIG. 3, in at least one embodiment of the instructor interface 200, an instructor may be able to access a student interface 300 by selecting a particular visual representation 220b. For example, FIG. 3 depicts an embodiment, where the selected visual representation 220b has been enlarged to aid the instructor in interacting with the student interface 300. In particular, the depicted student interface 300 includes a text entry portion 320 within which a student is coding a program. In at least one embodiment, an instructor can control a cursor and can select any portion of the student interface 300 as if the student interface belonged to the instructor. Additionally, any actions performed by the instructor on the student interface can be apparent to the associated student in real-time, or near real-time. Similarly, student-driven manipulations applied to the student interface can also be apparent to the instructor in real-time or near real-time. Accordingly, in at least one embodiment, similar to the relationship that can exist in a real-world classroom, a student and an instructor can collaboratively work on a student's project simultaneously.

In addition to the ability to collaborate within a student interface 300, in at least one implementation, instructors and students can also communicate through a messages function 330. In particular, an instructor or student can select the messages function 330 and communicate through text messages, oral communication, or video conferencing. A messages function 330 may also be available that allows an instructor to communicate with an entire class at the same time.

A student interface 300 may also allow an instructor to submit an arbitrary or predefined keystroke to the students interface. For example, an instructor would be prevented from sending some specific keystrokes to a student interface 300 because the instructor's computer system would intercept the keystrokes before they could be sent. For instance, if at student interface relates to a WINDOWS operating system and the instructor wants to access task manager within the student interface 300. If the instructor selects the student interface 300 and then pushes control-alt-delete, the instructor's computer system will intercept the keystrokes and launch the task manager itself. Accordingly, the send keystroke command 340 allows an instructor to send a keystroke sequence to a student interface 300 and avoid the instructor's computer system.

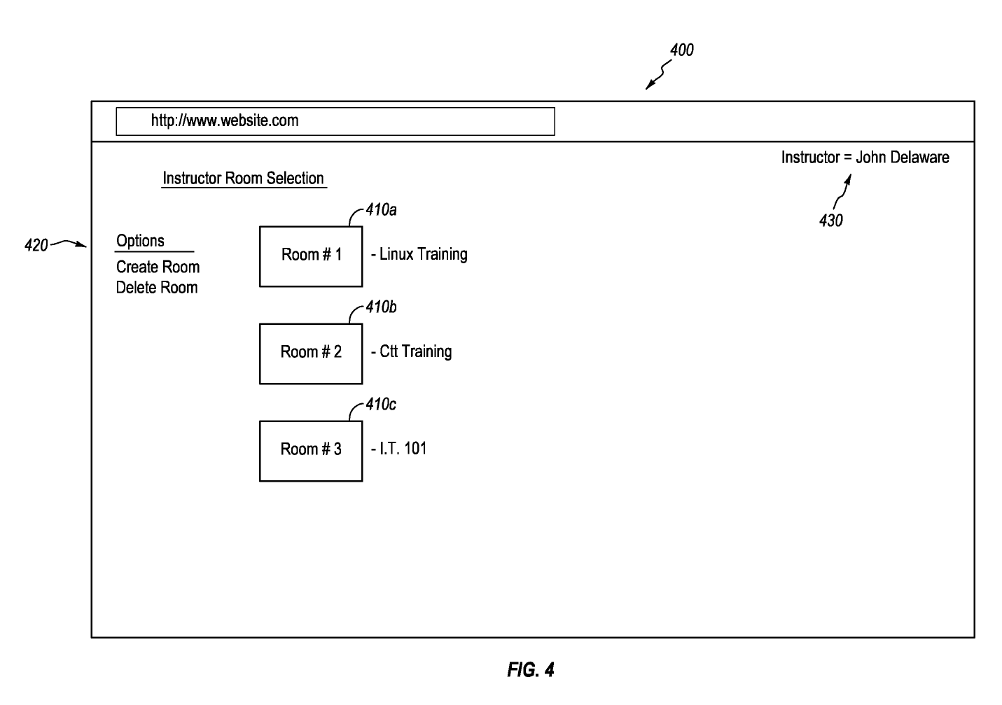

Turning now to FIG. 4, in at least one embodiment, an instructor may be associated with multiple virtual classrooms. For example, an instructor 430 may be teaching virtual classes on Linux, C++, and I.T. 101. Accordingly, in at least one embodiment, a classroom selection interface 400 is provided that allows the instructor 430 to enter various specific virtual classrooms 410(a-c). Similar to the previous interfaces, the classroom selection interface 400 may be accessible through a web browser, a stand-alone application, or through some other common framework.

Once within the classroom selection interface 400, the instructor 430 may be provided with options 420 to create a virtual classroom and/or delete a virtual classroom. In the case that the instructor 430 wishes to offer a new class, the instructor 430 can select “create room” and be provided with various options associated with the creation of a virtual classroom. The provided options 420 may include one or more of number of allowable enrollees, class topic, required virtual machines, class schedule, enrollment cost, and other related class specific configurations.

In at least one embodiment, only administrators can create and delete virtual classes. Accordingly, in this case, the instructor 430 can only create or delete a class if the instructor 430 also happens to be an administrator. Restricting instructor control in this way may provide a method for administrators to manage and control the virtual classes that are being offered by a particular organization.

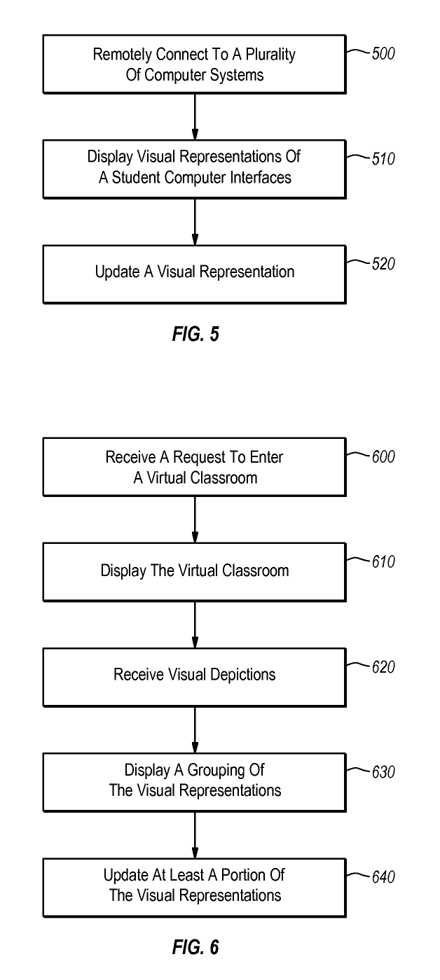

Accordingly, FIGS. 1-4 and the corresponding text illustrate or otherwise describe one or more components, modules, and/or mechanisms creating various interfaces within a virtual classroom and for managing the interfaces. One will appreciate that implementations of the present invention can also be described in terms of methods comprising one or more acts for accomplishing a particular result. For example, FIGS. 5 and 6 and the corresponding text illustrate or otherwise describe a sequence of acts in a method for displaying information to an instructor relating to the activities of one or more students within a virtual classroom. The acts of FIGS. 5 and 6 are described below with reference to the components and modules illustrated in FIGS. 1-4.

For example, FIG. 5 illustrates that a method for displaying information to an instructor relating to the activities of one or more students within a virtual classroom may include an act 500 of remotely connecting to a plurality of computer systems. Act 500 includes remotely accessing a plurality of computer systems. The plurality of computer systems may include student computer interfaces configured to provide students with one or more necessary components for a lesson. Additionally, the plurality of student computer interfaces can all be associated with a specific virtual classroom. For example, in FIGS. 1-3 and the accompanying description, the virtual classroom management application 100 can remotely access a plurality of student computer systems 110(a-c), which are each associated with various students from a particular virtual class. The various student computer systems 110(a-c) are further depicted and described as comprising student computer interfaces 112, 114, 116 that provide the students with the components necessary for a lesson.

FIG. 5 also shows that the method may include an act 510 of displaying visual representations of a student computer interface. Act 510 includes displaying, within a first instructor interface, visual representations of a plurality of the student computer interfaces. The visual representations can depict views of the plurality of the student computer interfaces as seen by the students within the students' respective student computer interfaces. For example, FIGS. 2 and 3, and the accompanying descriptions, depict and disclose, an instructor interface 200 that includes visual representations 220(a-e) that depict student interfaces. For instance, FIG. 3 depicts an instructor interface 200 that is accessing an enlarged visual representation of a student interface 300.

Additionally, FIG. 5 also shows that the method may include an act 520 of updating a visual representation. Act 520 includes updating at least a portion of the visual representations to include a visual depiction of student-driven manipulations applied to the respective student computer interfaces. For example, FIGS. 2 and 3, and the accompanying descriptions, disclose visual depictions 220(a-e) that update with sufficient frequency that an instructor is able to observe the changes that a student makes to his or her respective student interface, as the changes are being made.

In addition to the foregoing, FIG. 6 illustrates that additional or alternative actions performed by a system including a virtual classroom module may include an act 600 of receiving from an instructor a request to enter a virtual classroom. For example, FIG. 4 and the accompanying description depict and disclose a classroom selection interface 400 that allows an instructor to select a particular virtual classroom 410(a-c) to enter.

FIG. 6 also shows that the system may include an act 610 of displaying a virtual classroom. Act 610 includes displaying, within an instructor interface, the particular virtual classroom that is associated with a plurality of students enrolled within the virtual classroom. For example, FIG. 2 depicts an instructor interface 200 that relates to a virtual classroom. The depicted virtual classroom is associated with a plurality of students 220(a-e).

Additionally, FIG. 6 also shows that the system may include an act 620 of receiving visual representations. Act 620 includes receiving visual representations depicting views of student computer interfaces as seen by the plurality of students within the students' respective student computer interfaces. For example, FIG. 1, and the accompanying description, depicts and discloses, a visual representation update module 124 that is configured to receive information from the plurality of student computer interfaces 112, 114, 116 and transmit visual representations to the instructor computer system 150.

Further, FIG. 6 also shows that the system may include an act 630 of displaying a grouping of the visual representations. Act 630 includes displaying, within the instructor interface, a grouping of the visual representations such that at least one visual representation for each student is displayed within a single viewable page. For example, FIG. 2, and the accompanying description, depicts and discloses, an instructor interface 200 that includes visual representations 220(a-e). In particular, the instructor interface 200 depicts, within the same viewable screen, at least one visual representation 220(a-e) associated with each student within the virtual class. In at least one implementation, a sufficient number of student computer interfaces 112, 114, 116 may be within the virtual classroom that the instructor is required to scroll a page down in order to view the entire class. In an alternative implementation, the student computer interfaces 112, 114, 116 can shrink to fit the amount of screen that is available to an instructor.

Further still, FIG. 6 also shows that the system may include an act 640 of updating at least a portion of the visual representations. Act 640 includes updating at least a portion of the visual representations to include a visual depiction of student-driven manipulations applied to the respective student computer interfaces. For example, FIGS. 2 and 3, and the accompanying descriptions, disclose visual depictions 220(a-e) that update with sufficient frequency that an instructor is able to observe the changes that a student makes to his or her respective student interface, as the changes are being made.

Accordingly, FIGS. 1-6 and the corresponding text illustrate or otherwise describe a number of components, schematics, and mechanisms for managing a virtual classroom and for providing an instructor a virtual classroom that mirrors, in functionality, a real-world classroom experience. One will appreciate that the components and modules disclosed herein can allow an instructor to manage students and interactive with students in real-time or near real-time based upon the instructor's observations of the student's work. For example, an instructor can view within a visual representation, a student making a particular error. In response to identifying the error, the instructor can message the student and interactively work through the particular problem with the student within his or her student interface.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may relate to or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention may include at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions relate to, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may relate to a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computerized environment comprising an interactive virtual instructor interface and teaching environment, a computerized method for displaying information to an instructor relating to the activities of one or more students within a virtual classroom, the method comprising:
remotely communicating with a plurality of computer systems, wherein the plurality of computer systems comprise student computer interfaces configured to provide students with one or more necessary components for a virtual class, and further wherein, the plurality of student computer interfaces are all associated with a specific virtual classroom;
displaying, within a first instructor interface, visual representations of a plurality of the student computer interfaces, wherein the visual representations depict views of the plurality of the student computer interfaces as seen by the students within the students' respective student computer interfaces; and
updating at least a portion of the visual representations to include a visual depiction of student-driven manipulations applied to the respective student computer interfaces.

2. The computerized method as recited in claim 1, further comprising:
receiving a requested update frequency regarding one or more of the visual representations, wherein the requested update frequency indicates a speed at which the one or more visual representation should be updated; and
adjusting the frequency at which the one or more visual representations are updated.

3. The computerized method as recited in claim 2, wherein the requested update frequency is received from a specific student and is regarding one or more visual representations that are associated with the specific student.

4. The computerized method as recited in claim 1, wherein the updating at least the portion of the visual representations occurs with significant enough frequency to capture within the visual representations each of the student-driven manipulations as they appear on the computer interfaces as seen by the students within the students' respective student computer interfaces.

5. The computerized method as recited in claim 1, wherein the first instructor interface depicts all of the visual representations of the plurality of the student computer interfaces within a single viewable screen.

6. The computerized method as recited in claim 1, further comprising:
displaying, within the first instructor interface, one or more pre-defined visual indicators indicating information regarding the current state of a particular student computer interface.

7. The computerized method as recited in claim 6, wherein at least one of the visual indicators comprises a graphical indication of the last time the student interacted with their interface.

8. The computerized method as recited in claim 1, wherein the plurality of student computer interfaces comprise individual virtual machines running one or more operating systems.

9. The computerized method as recited in claim 8, further comprising:
displaying, to a remote student user, a first student computer interface, wherein the first student computer interface is rendered within a web browser; and
further wherein the first student computer interface is rendered using Application Programming Interfaces that are native to the web browser.

10. The computerized method as recited in claim 9, further comprising:
rendering the first student computer interface using HTML and Application Programming Interfaces that are native to the web browser.

11. The computerized method as recited in claim 1, further comprising:
receiving, from an instructor, a instruction directed towards a particular student computer interface associated with a particular student, wherein the instruction is configured to be executed within the particular student computer interface; and
providing the instruction to the particular student computer interface, wherein the instruction is executed by the particular student computer interface without any interaction by the particular student.

12. The computerized method as recited in claim 1, further comprising:
receiving an instruction to restore at least one student computer interfaces to a previous state;
accessing stored information regarding the previous state of the at least one student computer interface; and
reverting the at least one student computer interface to the previous state.

13. A computer-based system configured to display information to an instructor regarding the activities of one or more students within a virtual classroom, the system comprising:
a virtual classroom module executed on an instructor computer system that includes one or more processors and one or more hardware storage devices, the virtual classroom module configured to:
receive from the instructor a request to enter a particular virtual classroom;
display, within an instructor interface, the particular virtual classroom, wherein the particular virtual classroom is associated with a plurality of students enrolled within the virtual classroom;
receive visual representations depicting views of student computer interfaces as seen by the plurality of students within the students' respective student computer interfaces;
display, within the instructor interface, a grouping of the visual representations such that at least one visual representation for each student is displayed within a single viewable page; and
update at least a portion of the visual representations to include a visual depiction of student-driven manipulations applied to the respective student computer interfaces.

14. The computer-based system as recited in claim 13, further configured to:
receive a requested update frequency regarding one or more of the visual representations, wherein the requested update frequency indicates a speed at which the one or more visual representation should be updated; and
adjust the frequency at which the one or more visual representations are updated.

15. The computer-based system as recited in claim 14, wherein the requested update frequency is received from the instructor and is regarding one or more visual representations that are associated with the particular virtual classroom.

16. The computer-based system as recited in claim 13, further configured to:
generate a requested update frequency regarding one or more of the visual representations based upon signal quality between the virtual classroom module and one or more student computer systems associated with the one or more visual representations, wherein the requested update frequency indicates a speed at which the one or more visual representation should be updated; and
adjust the frequency at which the one or more visual representations are updated.

17. The computer-based system as recited in claim 13, wherein the updating the at least the portion of the visual representations occurs with a great enough frequency to capture within the visual representations each of the student-driven manipulations as they appear on the computer interfaces as seen by the students within the students' respective student computer interfaces.

18. The computer-based system as recited in claim 13, further configured to:
receive a first modification from the instructor, wherein the first modification is directed towards modifying a particular element within a specific student computer interface;
receive a second modification from a particular student associated with the specific student computer interface, wherein the second modification is also directed towards modifying the particular element within the specific student computer interface; and
simultaneously display within the instructor interface both the first modification and the second modification;

19. The computer-based system as recited in claim 13, further configured to:
display one or more visual indicators indicating a student's progress within a particular student computer system associated with a particular visual.

20. In a computerized environment comprising one or more computer systems having one or more processors, one or more physical storage media comprising computer executable instructions that, when executed by the one or more processors cause the one or more computer systems to display information to an instructor relating to the activities of one or more students within a virtual classroom in a millwork facility, the one or more processors performing the following:
remotely a communicating with a plurality of computer systems, wherein the plurality of computer systems comprise student computer interfaces configured to provide students with one or more necessary components for a virtual class, and further wherein, the plurality of student computer interfaces are all associated with a specific virtual classroom;
displaying, within a first instructor interface, visual representations of a plurality of the student computer interfaces, wherein the visual representations depict views of the plurality of the student computer interfaces as seen by the students within the students' respective student computer interfaces; and
updating at least a portion of the visual representations to include a visual depiction of student-driven manipulations applied to the respective student computer interfaces.
